(19) United States
(12) Patent Application Publication
(10) Pub. No.: US 2025/0292209 A1
(43) Pub. Date: Sep. 18, 2025

(54) FUSED VECTOR STORE FOR EFFICIENT RETRIEVAL-AUGMENTED AI PROCESSING

(71) Applicant: NVIDIA Corporation, Santa Clara, CA (US)

(72) Inventor: Ryan Angilly, Denver, CO (US)

(21) Appl. No.: 18/674,734

(22) Filed: May 24, 2024

Related U.S. Application Data
(60) Provisional application No. 63/566,105, filed on Mar. 15, 2024.

(51) Int. Cl. G06Q 10/10; G06F 40/10

(52) U.S. Cl. CPC G06Q 10/103; G06F 40/10

(57) ABSTRACT

In various examples, systems and techniques are provided that encapsulate indexing and query operations into an application programming interface (API) that automates and coordinates calls to various local and cloud-based services. When a user has a document(s) to add to a retrieval augmented generation (RAG) database, the API may offer to the user multiple document processing pipelines (DPPs) having pre-set indexing configurations. Similarly, when a user query is received, the API may generate calls to implement query processing that does not require the user to manually configure retrieval and processing of the embeddings. The API may further implement calls that locate a relevant embedding store and provide the stored embeddings, together with the query embeddings, to a search engine that identifies the most relevant matches. The API may then access the embedding-to-text indexing and identify relevant text segments and documents to a prompt generator.

### RELATED APPLICATIONS

This application claims the benefit of U.S. Provisional Patent Application No. 63/566,105, filed Mar. 15, 2024, entitled “FUSED VECTOR STORE FOR EFFICIENT RETRIEVAL-AUGMENTED AI PROCESSING,” the contents of which are incorporated by reference in their entirety herein.

### TECHNICAL FIELD

At least one embodiment pertains to facilitating efficient processing of data using artificial intelligence (AI) systems. For example, at least one embodiment pertains to augmentation of AI processing with stored vectors representative of content of documents and other data relevant for AI operations.

### BACKGROUND

Well-trained language models—such as large language models (LLMs)—are capable of supporting conversations in natural language, understanding speaker's intent and emotions, explaining complex topics, generating new texts upon receiving suitable prompts, providing advice regarding topics of interest to a user, processing image, audio, and/or other data types, and/or performing other functions. LLMs typically undergo self-supervised training on massive amounts of text data and/or other data types, depending on the embodiment, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, LLMs often undergo instructional (prompt-based) supervised fine-tuning that causes LLMs to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts.

### BRIEF DESCRIPTION OF DRAWINGS

FIG. 1 is a block diagram of an example computing architecture capable of implementing efficient retrieval-augmented generation (RAG) for augmentation of inputs into AI models, according to at least one embodiment;

FIG. 2 illustrates an example computing device that supports efficient RAG for AI model processing, according to at least one embodiment. In at least one embodiment, according to at least one embodiment;

FIG. 3 illustrates an example data flow of a document indexing stage of efficient RAG for AI model processing, according to at least one embodiment;

FIG. 4 illustrates an example data flow of a query processing stage of efficient RAG for AI model processing, according to at least one embodiment;

FIG. 5 is a flow diagram of an example method of an indexing stage of efficient API-facilitated RAG for AI model processing, according to at least one embodiment;

FIG. 6 is a flow diagram of an example method of a query processing stage of efficient API-facilitated RAG for AI model processing, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

Training of language models (LMs), including large language models (LLM) and/or vision language models (VLMs), typically involves large volumes of training data (e.g., human-created texts) and teaches LMs to generate responses to user queries including questions, requests for information, advice, explanations of various general and specialized subjects, images, video, audio, digital assets, and/or the like. Since the number of topics that can be of interest to users is practically unlimited, LMs are regularly tasked with responding to queries about things and concepts that have not been extensively represented in the training data. Such queries can lead to suboptimal responses that can be incorrect and/or misleading.

Retrieval-augmented generation (RAG) is the technique that improves outputs of the LMs by augmenting LM inputs (queries) with additional information that may be of relevance to the inputs, e.g., information that includes context, data, specialized knowledge about the subject of the query, and so on. Such additional information may be stored in the form of embeddings—feature vectors or vectors in a special N-dimensional embedding space—that encode words, sub-words, characters, etc. together with their contextual connections. A trained encoder may encode strings of text into embeddings, which may be considered as points in the embedding space. During training, the encoder learns to associate similar strings of text with similar embeddings corresponding to points closely situated in the embedding space and further learns to associate dissimilar strings of text with points that are located farther apart in the embedding space. A contextual information relevant to a particular LM query may be presented in the form of such embeddings, which may be previously generated, for faster retrieval, and stored in a suitable data store.

To take advantage of the RAG techniques, a received LM query may similarly be converted into embeddings, each embedding encoding a portion of the input query. These query embeddings may then be compared to embeddings stored in the data store. For example, similarity factors (e.g., scalar products) of pairs of embeddings may be computed and a set of stored embeddings most closely related to the query embedding may be identified. A corresponding—to the identified embeddings—portions of documents may then be included into the user-generated query, as part of the contextual information, to generate a prompt that is used as an input into the LM, causing the LM to produce a more relevant and accurate response. The existing RAG techniques, however, come at significant costs in terms of developer's time and processing resources.

More specifically, during an indexing stage of building an RAG-enhanced application, a user or a developer may first select a set of documents relevant to a particular field of knowledge and then run a code (e.g., LangChang or Llamaindex-based code) on a local (e.g., user's) computer to split the documents into segments of a desired size (such segments may overlap). The segments of documents may be uploaded to, e.g., a cloud-based embedding model that converts the segments into embeddings, which are subsequently downloaded to the local computer. The embeddings may then be uploaded to a user's cloud space and stored in a vector database for use in subsequent user queries. The embeddings in the vector database may be indexed to the original text segments, which may be stored (e.g., also on cloud) in a separate text store. During a query stage of RAG processing, the embeddings may again be downloaded to the local computer and compared to the embeddings representing a user's query. Following identification of the most relevant (e.g., most similar to the query embeddings) downloaded embeddings, the embedding-to-text indexing may be used to identify the corresponding segments of the stored contextual information. These most relevant segments may be downloaded from the text store to the local computer and an LM prompt may be generated, e.g., using the original user's query and the downloaded segments. The generated prompt may then be uploaded to an LM service for processing.

The described operations of the indexing and the query stages are complex and involve calls to multiple local and cloud services. Coding and optimizing such calls require significant developer's efforts, coding experience, and knowledge of various RAG tools, which may be beyond the abilities of many users.

Aspects and embodiments of the present disclosure address these and other challenges facing users and developers of RAG-facilitated applications by providing for systems and techniques encapsulating the indexing and query operations into an API that automates and coordinates calls to various local and cloud-based services. In some embodiments, when a user has a document (or multiple documents) to add to a RAG database, the API may offer to the user multiple document processing pipelines (DPPs) having pre-set indexing configurations. For example, a given DPP may have a preset size of text segments (in characters, words, sentences, lines, and/or the like), an amount of segment overlap, a number K of the top search matches to be returned, and/or the like. The DPP may further specify an embedding model to be used with the segments, including a cloud-based location of the embedding model, an embedding-to-text mapping scheme, a location for storage of the embeddings and/or the text segments, and/or other relevant information. The user-selected (or a default) DPP may automatically implement indexing instructions according to pre-programmed calls. In particular, the selected DPP may have the document(s) segmented, embedded, stored in the embedding and text data stores, and/or the like. The generated embeddings may then be indexed to the corresponding text segments. Similarly, when a user query is received, the API may generate calls to implement query processing that does not require the user to manually configure retrieval and processing of the embeddings. The API may further implement calls that locate a relevant embedding store and provide the stored embeddings, together with the query embeddings, to a search engine that identifies the most relevant matches. The API may then access the embedding-to-text indexing and identify the most relevant text segments and documents to a prompt generator.

An LM prompt generated with the original user's query and the identified text segments may be provided to the LM. In some embodiments, K top matches (most relevant segments) may be included in the prompt in an unranked form. In some embodiments, K top matches may be provided to the LM as a ranked list. In some embodiments, an additional model may be used to re-rank the top matches, based on relevance to the user's query before generating the LM prompt. In some embodiments, a preliminary prompt into the same LM (or a separate LM) may be used to task the LM with the re-ranking of the top matches before generating a final prompt for the LM model with the re-ranked matches. In some embodiments, any, some, or all indexing and/or query operations may be performed on cloud, e.g., the user's cloud space. For example, a service that supports the RAG infrastructure and provides the API(s) may also provide a fully functional and portable container (e.g., a Docker container) that can operate on the user's local computer or the user's cloud space. The container may include any, some or all of the API, API calls, DPPs, segmentation engine, embedding model, search engine, re-ranking model, and/or the like and may facilitate secure execution of the RAG application independently of (an in parallel to) other user-run applications while keeping it independent of other environments that may run in parallel.

The advantages of the disclosed embodiments include (but are not limited to) efficient and automated operations of indexing and query RAG processing that coordinates calls to various processing and memory resources and does not have complexity of traditional techniques that rely on user's expertise and sophistication. Since the disclosed embodiments do not rely on a RAG code and/or local processing, intermingling of a RAG code with a code that implements a specific RAG-facilitated application code is avoided. In some embodiments, the disclosed API and other techniques facilitate moving the RAG operations on cloud, which frees local computing and memory resources for other tasks.

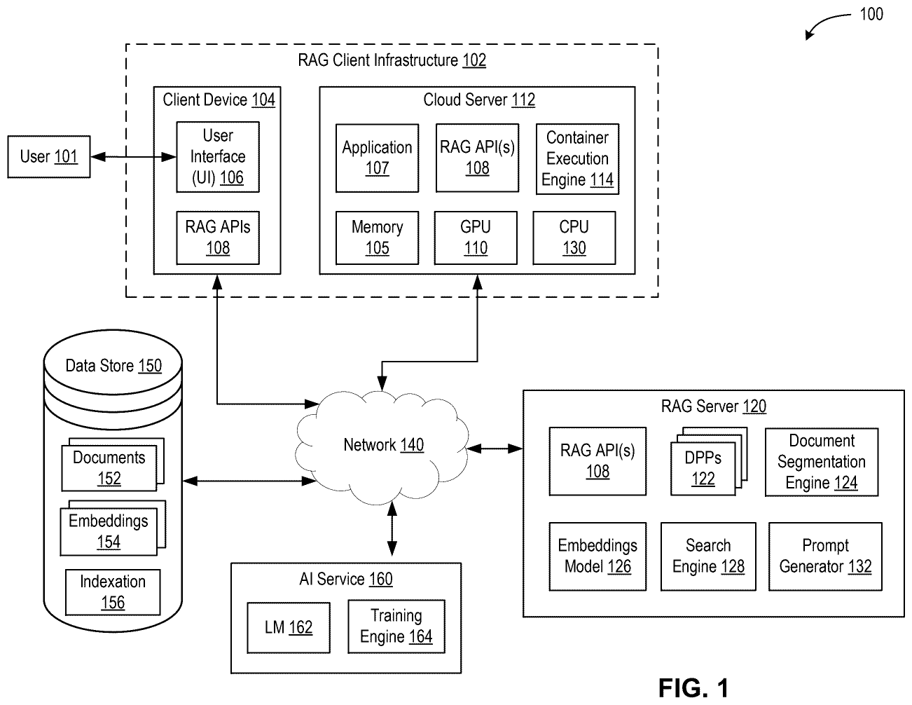

FIG. 1 is a block diagram of an example computing architecture 100 capable of implementing efficient retrieval-augmented generation (RAG) for augmentation of inputs into AI models, according to at least one embodiment. As depicted in FIG. 1, computer architecture 100 may include a RAG client infrastructure 102, a RAG server 120, a data store 150, and an AI service 160 connected via a network 140. Network 140 may be a public network (e.g., the Internet), a private network (e.g., a local area network (LAN), or wide area network (WAN)), a wireless network, a personal area network (PAN), a combination thereof, and/or another network type.

RAG client infrastructure 102 may include one or more computing devices accessible to a user 101 and facilitating efficient use by user 101 of one or more AI models provided by AI service 160. In one example non-limiting embodiment, AI models may include an LM 162, but it should be understood that services associated with various other AI models may similarly be improved with the disclosed techniques, e.g., automatic speech recognition (ASR) models, computer vision (CV) models, text-to-speech models, anomaly detection models, action detection models, object detection models, and/or any other suitable generative or discriminative AI models. In some implementations, RAG client infrastructure 102 may include a client device 104, which may be (or include) one or more computing devices that are under control of user 101, e.g., a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. User 101 may be a person (e.g., an individual user) or an organization (e.g., a collective user). Client device 104 may include a memory and one or more processors (not shown in FIG. 1 for conciseness) communicatively coupled to the memory to support local computations on client device 104.

In some implementations, client device 104 may provide a user interface (UI) 106 to support receiving documents (or other data) and user queries (or other inputs of AI models) from user 101 and providing to user 101 responses to user queries (or any other outputs of AI models). UI 106 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, UI 106 may include an audio device, e.g., a combination of a microphone and a speaker, a video device, such as a digital camera to capture an image or a sequence of two or more images (video frames). In some embodiments, text, speech, and/or video input devices may be integrated together, e.g., as part of a smartphone, tablet computer, desktop computer, and/or the like.

Client device 104 may implement access of user 101 to a cloud server 112 that implements cloud-based computation, storage of data, authentication of data, and/or any other services that may be provided to user 101 as part of paid or free subscription. Processing and storage of data on cloud server 112 may be protected using any suitable cryptographic protection techniques, including but not limited to symmetric and asymmetric key cryptography, digital authentication, and/or the like.

Cloud server 112 may deploy one or multiple computing devices, which may include a memory 105 (e.g., one or more memory devices or units) communicatively coupled to one or more processing devices, such as one or more graphics processing units (GPU) 110, one or more central processing units (CPU) 130, one or more data processing units (DPU), one or more parallel processing units (PPUs), and/or other processing devices (e.g., field-programmable gate arrays (FPGAs), application-specific integrated circuits (ASICs), and/or the like). Memory 105 may include a read-only memory (ROM), a flash memory, a dynamic random-access memory (DRAM), such as synchronous DRAM (SDRAM), a static memory, such as static random-access memory (SRAM), and/or some other memory capable of storing digital data. Cloud server 112 may support execution of an application 107, which may be a text processing application, a video processing application, an audio processing application, a gaming application, an image or video rendering application, a computational application, a data processing application, a browsing application, and/or any other suitable application. Application 107 may be remotely provided to user 101 via UI 106 and client device 104.

RAG server 120 may deploy one or more processing devices (not shown in FIG. 1) and may operate to augment AI service 160. In some implementations, RAG server 120 may be operated as part of AI service 160 (e.g., under control of the same entity). In some implementations, RAG server 120 may be operated independently of AI service 160 but may support inference operations of clients (such as user 101) using AI service 160.

In some implementations, AI service 160 may deploy LM 162, which may be a large language model, e.g., a model with at least 100K of learnable parameters, and/or a visual language model (VLM). LM 162 may be trained by training engine 164. In some embodiments, LM 162 may be trained in multiple stages. Initially, training engine 164 may train LM 162 to capture syntax and semantics of human language, e.g., by training to predict a next, a previous, and/or a missing word in a sequence of words (e.g., one or more sentences of a human speech or text). LM 162 may be further trained using training data containing a large number of texts, such as human dialogues, newspaper texts, magazine texts, book texts, web-based texts, and/or any other texts. Since ground truth for such training is embedded in the texts themselves, training engine 164 may use such texts for self-supervised training of LM 162. This teaches LM 162 how to carry out a conversation with a user (a human user or another computer) in a natural language in a manner that closely resembles a dialogue with a human speaker, including understanding the user's intent and responding in ways that the user expects from a conversational partner. Following the initial self-supervised training, training engine 164 may implement a supervised fine-tuning of LM 162 to teach LM 162 more specialized language skills, including expertise in a particular field of knowledge.

LM 162 may be implemented using neural networks with a large number (e.g., billions) of artificial neurons. In at least one embodiment, LM 162 may be implemented as a deep learning neural network having multiple levels of linear and non-linear operations. For example, LM 162 may include convolutional neural networks, recurrent neural networks, fully-connected neural networks, long short-term memory (LSTM) neural networks, neural networks with attention, e.g., transformer neural networks, a combination of a convolutional network and one or more transformers (a conformer), and/or neural networks of other types. In at least one embodiment, LM 162 may include multiple neurons, with an individual neuron receiving its input from other neurons and/or from an external source and producing an output by applying an activation function to the sum of weighted (using trainable weights) inputs and, possibly, a bias value. In at least one embodiment, LM 162 may include multiple neurons arranged in layers, including an input layer, one or more hidden layers, and/or an output layer. Neurons from adjacent layers may be connected by weighted edges.

Initially, parameters (e.g., edge weights and biases) of LM 162 may be assigned some starting (e.g., random) values. For various training inputs, training engine 164 may cause LM 162 to generate training output(s). Training engine 164 may then compare training output(s) with the desired target output. The resulting error or mismatch, e.g., the difference between the target output(s) and the training output(s), may be backpropagated through various neural layers of LM 162, and the weights and biases of LM 162 may be adjusted to make the training outputs closer to the target outputs. In some embodiments, training engine 164 may train multiple LMs 162 for multiple tasks, e.g., multiple different fields of knowledge.

In some embodiments, RAG server 120 may include one or more RAG APIs 108 that provide, to a user, a set of commands that can be understood by a non-expert user and may implement any, some, or all operations of the document indexing stage and/or query processing stage for augmentation of AI processing. The commands made available via RAG API(s) 108 may include selecting a specific document processing pipeline (DPP) having pre-set indexing and/or query processing configurations. RAG service infrastructure may define any number of preset DPPs. Once selected, a DPP may implement various processing operations with minimal or no user input, including but not limited to issuing calls to operate a document segmentation engine 124 to segment input documents according to the DPP settings, an embeddings model 126 to convert the document segments into feature vectors (embeddings), and a search engine 128 to perform search in the embedding space for relevant document segments.

In some implementations, an API package with RAG API(s) 108 may be downloaded to one of the computing devices of cloud server 112. The downloaded API package may be used to install RAG API(s) 108 to enable user 101 to deploy augmented AI processing on, via, or using cloud server 112. For example, user 101 may identify a document stored on client device 104 or elsewhere (e.g., in data store 150) and select a DPP 122 for indexation of the document. Responsive to receiving the DPP selection, RAG API(s) 108 may execute one or more preprogrammed calls to upload the identified document to RAG server 120 for processing using document segmentation engine 124 and embeddings model 126. Processed, e.g., segmented, documents 152 may be stored in data store 150 together with embeddings 154 associated with segmented documents 152. Similarly, a user query submitted by user 101, e.g., via UI 106 of client device 104, may be forwarded to RAG server 120 for processing. RAG server 120 may apply embeddings model 126 to the user query to generate query embeddings and may further apply search engine 128 to identify stored embeddings 154 that are most similar to the query embeddings. A prompt generator 132 may then augment the user query with segments of stored documents 152, e.g., using indexation 156 of embeddings 154 to corresponding portions of documents 152 that the embeddings 154 represent. In some implementations, RAG API(s) 108 may be downloaded to client device 104 and may execute preprogrammed calls to RAG server 120 without the use of cloud server 112.

In some implementations, any, some, or all operations of RAG server 120 may be implemented on (or using) cloud server 112 using a container received from RAG server 120. More specifically, various codes implementing any, some, or all of RAG API(s) 108, DPPs 122, document segmentation engine 124, embeddings model 126, search engine 128, and/or prompt generator 132 may be packaged into an image container, e.g., a lightweight executable software package that may be provided to cloud server 112. The image container may further include various system tools, libraries, and settings. A container execution engine 114 (e.g., Docker engine or a similar container execution engine) operating on cloud server 112 may receive the container image and instantiate a RAG container from the container image. The instantiated container may run on the cloud server 112 in an isolated environment.

Documents 152, embeddings 154, indexation 156, and/or other data stored in data store 150 may be accessible to RAG server 120, cloud server 112, client device 104, and/or other computing devices not explicitly shown in FIG. 1 via a bus, interconnect, and/or the like, or via network 140. Data store 150 may include persistent storage and may be hosted by one or more storage devices, such as main memory, magnetic or optical storage disks, tapes, or hard drives, network-attached storage (NAS), storage area network (SAN), and so forth. Although depicted as separate from RAG server 120, cloud server 112, and/or client device 104, in at least some embodiments, data store 150 may be a part of RAG server 120, cloud server 112, and/or client device 104. In at least some embodiments, data store 150 may be a network-attached file server, while in other embodiments, data store 150 may be some other type of persistent storage, such as an object-oriented database, a relational database, and so forth, that may be hosted by RAG server 120, cloud server 112, and/or client device 104 or one or more different machines coupled to RAG server 120, cloud server 112, and/or client device 104.

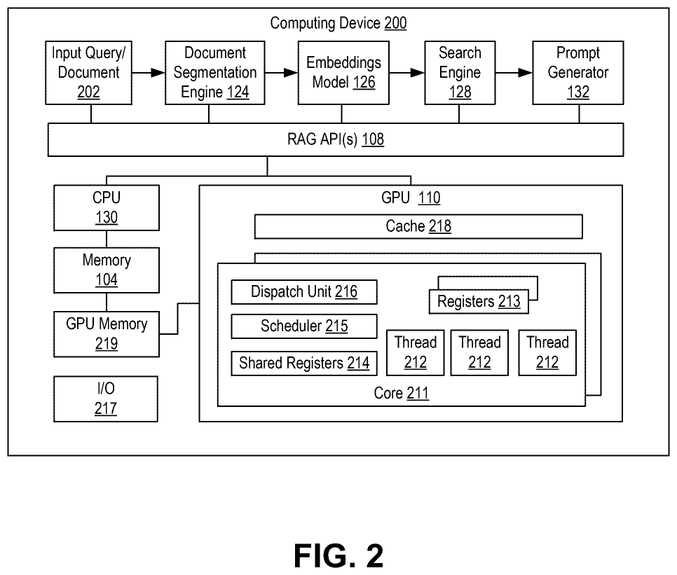

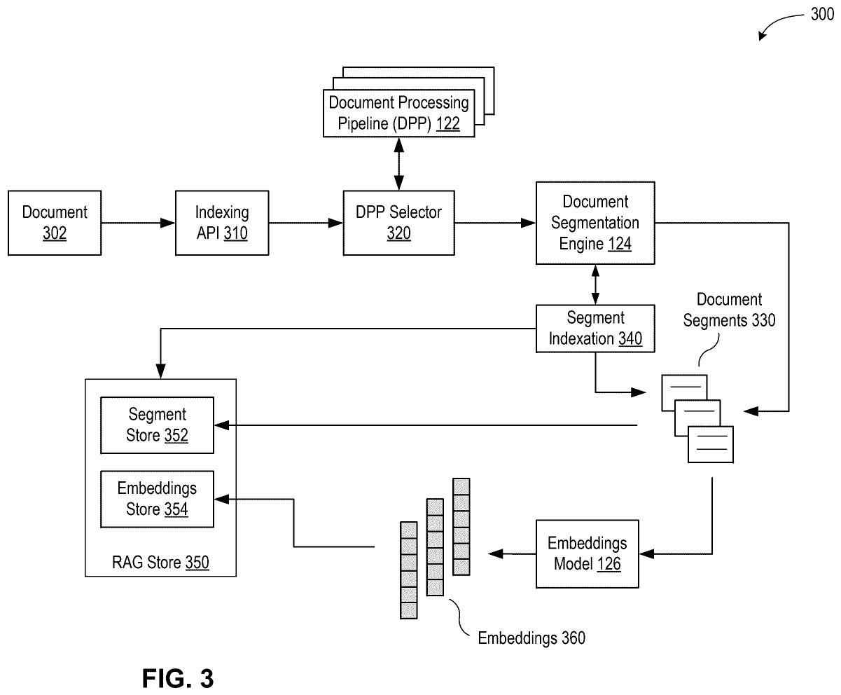

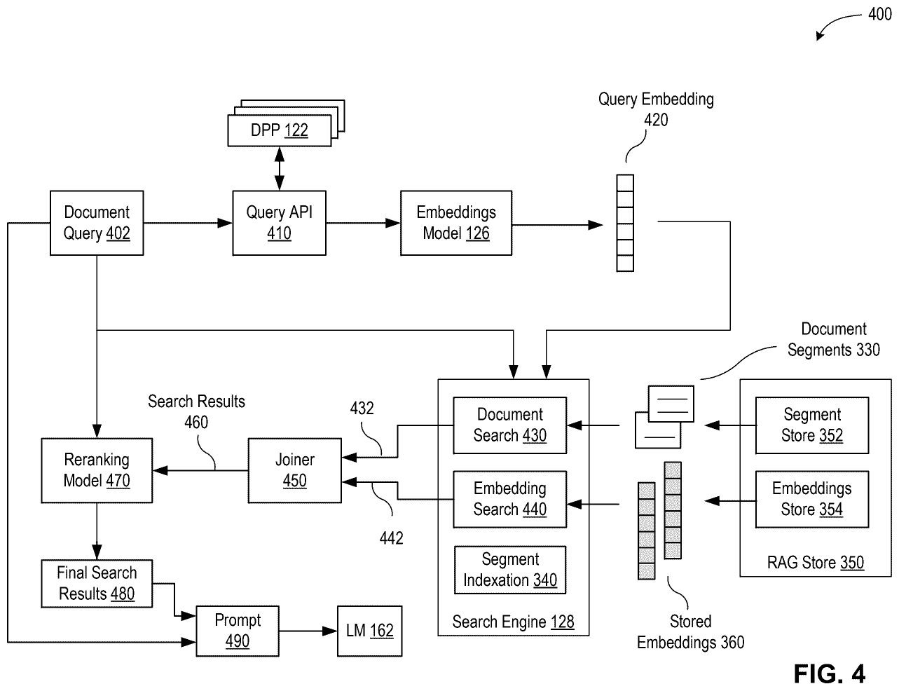

FIG. 2 illustrates an example computing device 200 that supports efficient RAG for AI model processing, according to at least one embodiment. In at least one embodiment, computing device 200 may be a part of RAG server 120, a part of cloud server 112, and/or a part of client device 104. In at least one embodiment, one or more RAG APIs 108 may operate on computing device 200. RAG API(s) 108 may facilitate processing of an input query/document 202, e.g., by operating document segmentation engine 124, embeddings model 126, search engine 128, prompt generator 132, and/or other components not explicitly depicted in FIG. 2 (e.g., as disclosed in conjunction with FIG. 3 and/or FIG. 4 below).

Operations and calls of RAG API(s) 108 and various modules operating in conjunction with RAG API(s) 108, and/or other software/firmware instantiated on computing device 200 may be executed using one or more GPUs 110, one or more CPUs 130, one or more parallel processing units (PPUs) or accelerators, such as a deep learning accelerator, data processing units (DPUs), and/or the like. In at least one embodiment, a GPU 110 includes multiple cores 211, each core being capable of executing multiple threads 212. Each core may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, each core 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 110 may have a (high-speed) cache 218, access to which may be shared by multiple cores 211. Furthermore, computing device 200 may include a GPU memory 219 where GPU 110 may store intermediate and/or final results (outputs) of various computations performed by GPU 110. After completion of a particular task, GPU 110 (or CPU 130) may move the output to (main) memory 105. In at least one embodiment, CPU 130 may execute processes that involve serial computational tasks whereas GPU 110 may execute tasks (such as multiplication of inputs of a neural node by weights and adding biases) that are amenable to parallel processing.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing generative AI operations, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implementing one or more visual language models (VLMs), systems implemented at least partially using cloud computing resources, and/or other types of systems.

Although, for brevity and conciseness, the description throughout this disclosure often refers to text inputs, text documents, text queries, and/or the like, it should be understood that the disclosed techniques are also applicable to indexing and retrieval of images (including structured images), data (including structured data), and any other inputs/data, including multimodal data that includes a combination of texts and images, texts and audio, and/or the like. A “document,” as used herein should be understood as any digital data capable of being segmented into portions having semantic meaning, e.g., a paragraph of a text, a part of an image, a table (or equivalent, e.g., a plot) of a data set, one or more frames of a video file, a portion of an audio file, and/or the like.

FIG. 3 illustrates an example data flow 300 of a document indexing stage of efficient RAG for AI model processing, according to at least one embodiment. Operations illustrated in FIG. 3 may be performed by client device 104, cloud server 112, RAG server 120, and/or other suitable computing device. Operations illustrated in FIG. 3 may be performed to process, embed, and index any suitable document 302, including a text document, an image, an audio file, a video file, a data file, and/or the like. (Although, for brevity and conciseness, a single document 302 is referenced throughout the description of FIG. 3, any batch of multiple documents 302 may be processed similarly, e.g., sequentially or in parallel.) In some implementations, document 302 may be associated with any general or specific area of knowledge, e.g., medical diagnostics, computing technology, mathematics, computer games, art history, and/or the like. Document 302 may be provided using any suitable means, including uploading by a user (e.g., user 101 in FIG. 1) or under control of the user, automatic data collection, database mining, and/or the like. In some instances, e.g., when document 302 is available as an image, document 302 may first undergo optical character recognition (OCR). Prior to (or as part of) the OCR, document 302 may be denoised, filtered, sharpened, or enhanced using any appropriate preprocessing tools or techniques.

Processing of document 302 may be facilitated by an indexing API 310, which may be a part of RAG API(s) 108 of FIG. 1 and FIG. 2. Indexing API 310 may make available, to the user or any other entity or software that uploads document 302, a DPP selector 320 capable of selecting from multiple DPPs 122. Different DPPs 122 may have different predetermined settings (configurations), including a size S of an individual segment of document 302. For example, in the instances of a text document 302, size S may be specified as a number of characters, words, sentences, lines, paragraphs, pages, and/or the like, e.g., 1000 characters, 200 words, one page, and so on. Settings of DPPs may further include an amount of segment overlap O between adjacent segments. The overlap O may also be specified via a number of words, sentences, and so on (e.g., 20 words, 100 characters, and/or the like), percents (e.g., 10%, 20%, and/or the like). Settings of DPPs may further include a number K of the top search matches to be returned, and/or the like. In some implementations, settings of DPPs 122 may also include a specific embedding model to be used to embed the segments. In some implementations, settings of DPPs 122 may specify a storage location for the embeddings and document segments, an embedding-to-segment mapping (indexation) scheme, and/or other relevant information. In some implementations, DPP selector 320 may specify a default DPP 122 that may be used in the instances where a user lacks preference, knowledge, or experience to make an informed DPP selection. The default DPP 122 may be dependent on the document type and may be different for a text document than for an image document.

“Embedding” (“feature vector” or, simply, vector) should be understood as any digital representation of a unit of data (e.g., a string of alphanumeric characters, an image or a portion of an image, a set or a subset of data, and/or the like) in a space—“embedding space”—of dimension N (a number of components of an individual vector), which may be set as part of training of a model (“embedding model”) used to represent (“embed”) data via points (vectors) in the N-dimensional embedding space. Components of embeddings (vectors) may have integer value or floating-point values. During training, an embedding model may learn to associate similar units of data with similar embeddings (vectors) corresponding to points closely situated in the embedding space and further learn to associate dissimilar units of data with points that are located farther apart in the embedding space.

The user-selected (or a default) DPP 122 may trigger operations of document segmentation engine 124 that segments document 302 into multiple document segments 330 according to settings of the selected DPP. The segments may be stored in a segment store 352, which may be implemented as part of RAG store 350. Document segmentation engine 124 may also perform segment indexation 340 by assigning unique indicators to various segments. For example, individual segments may be indexed by an identification (ID) of a document, a number denoting a location of the segment in the document, a storage location in segment store 352, and/or any other relevant information. Embeddings model 126 may process document segments 330 to generate embeddings 360. Embeddings 360 may be vectors in an N-dimensional embedding space. The dimension N may be fixed as part of architecture of embeddings model 126 or flexible, specified as part of the selected DPP 122. The generated embeddings may be stored in embeddings store 354, which may be implemented as part of the same RAG store 350 that hosts segment store 352 or as part of a different store. Stored embeddings 360 may also undergo segment indexation to uniquely identify various embeddings 360 and to map stored embeddings 360 to stored document segments 330, e.g., such that a given document segment 330 may be used to identify a corresponding embedding 360 encoding the same portion of document 302. In some implementations, RAG store 350 may store thousands or millions (or more) of documents 302 related to a single or multiple knowledge areas.

FIG. 4 illustrates an example data flow 400 of a query processing stage of efficient RAG for AI model processing, according to at least one embodiment. Operations illustrated in FIG. 4 may be performed by the same device that performed operations of FIG. 3. In some implementations, query processing may be performed by a different server of the same RAG client infrastructure 102 (with reference to FIG. 1), e.g., a different cloud server 112 or a different client device 104 having access to the RAG store 350 that stores document segments and embeddings. Operations illustrated in FIG. 4 may be performed to facilitate generation of efficient queries to an LM or to augment inputs into some other AI model. For example, similar operations may be performed to generate images that are based on user's instructions—e.g., descriptions of images—with one or more previously stored images to be identified and used to augment the user's instructions.

As illustrated, a document query 402, e.g., a text query, an audio query, and/or the like, may be received via a query API 410, which may be a part of RAG API(s) 108 of FIG. 1 and FIG. 2. In some implementations, query API 410 and indexing API 310 (of FIG. 3) may be implemented as a single API that facilitates both the intake of documents and query processing. In some implementations, query API 410 and indexing API 310 may be implemented as separate APIs. In some implementations, query API 410 may have access to multiple DPPs 122. A user (or process) that generated document query 402 may also select a DPP 122 to be used for the query processing. In some implementations, the user (or process) may select the same DPP 122 as was selected for processing (segmentation and embedding) of documents during the indexing stage. For example, a large document query 402 may be segmented into portions that have the same size S and overlap O as used to process documents associated (during the indexing stage) with the same field of knowledge. In some implementations, the user (or process) may select a different DPP 122 than the DPP 122 used to process documents during the indexing stage. In some implementations, the selected DPP 122 may specify a number K of the best (most pertinent) documents or segments of documents to be returned.

Document query 402 (appropriately segmented, if dictated so by the size of the query) may be converted into a query embedding 420 (or multiple query embeddings 420, for large queries). The generated query embedding 420 may be received by an embedding search module 440 of search engine 128. Embedding search module 440 may further receive, e.g., from embeddings store 354, stored embeddings 360 (which may be processed as disclosed in conjunction with FIG. 3). Embedding search module 440 may identify K stored embeddings 360 that are most similar to query embedding 420 (and, therefore, most pertinent to document query 402). In one example embodiment, a cosine similarity function may be used as part of embedding search 440, which computes a scalar product (dot product) of query embedding 420 (QE) and various stored embeddings 360 (SEⱼ, with j standing for any suitable ID of the stored embeddings):

$$Similarity ( QE , S {E}_{j} ) = \frac{QE \cdot {SE}_{j}}{\vert QE \vert \vert {SE}_{j} \vert} .$$

Having identified K best matches—e.g., K stored embeddings 360 having the highest Similarity scores with respect to query embedding 420—embedding search 460 may use segment indexation 340 to identify the corresponding K document segments, referred to as a first set of segments 442 herein. In some embodiments, embedding search module 440 may perform a search for relevant stored embedding 360 in the embeddings store 354. In some embodiments, such an embedding search may first be performed sparsely for a certain set of stored embeddings, e.g., with one or more stored embeddings 360 sampled (e.g., randomly or according to any suitable pattern, such as selecting every nth embedding) and compared to query embedding 420. A dense search of documents may then be performed in association with those stored embeddings 360 that had the highest similarity scores (e.g., text segments within a certain neighborhood of the most relevant hits).

In some implementations, an additional document search 430 may be performed among document segments 330 stored (e.g., in segment store 352) in raw format, e.g., in text form. Document search 430 may be a sparse search. In some implementations, document search 430 may be Elasticsearch or some other text search. Document search 430 may return a second set of segments 432. The first set of segments 442 and the second set of segments 432 may partially (or fully) overlap. Joiner 450 may eliminate duplicate segments and generate search results 460, e.g., a list of most similar—to the document query 402—document segments. In some implementations, joiner 450 may limit search results 460 to a number of top results, e.g., K most similar segments. In some implementations, some of the search results 460 may be ranked, e.g., in the order of decreased similarity scores, for the first set of segments 442 or in the order of word matches, for the second set of segments 432. In some implementations, segments in the search results 460 obtained by different searches may be unranked. In some implementations, all segments in the search results 460 maybe ranked using some common ranking scheme. For example, joiner 450 may retrieve embeddings for those segments that were obtained using document search 430 and were not captured by embedding search 440 and compute the corresponding similarity scores to rank all search results 460 using the common scheme based on the similarity scores.

In some implementations, search results 460 may be accepted as final search results 480. In some implementations, search results 460 may be provided to a reranking model 470 that re-ranks search results 460 in view of document query 402. In some implementations, reranking model 470 may be the same as LM 162. In other embodiments, reranking model 470 may be a separate model, e.g., a lightweight language model. Final search results 480 (originally ranked, reranked, or unranked) may be combined with document query 402 to form a RAG-enhanced prompt 490. Prompt 490 may then be provided for processing by LM 162 which may return a suitable response.

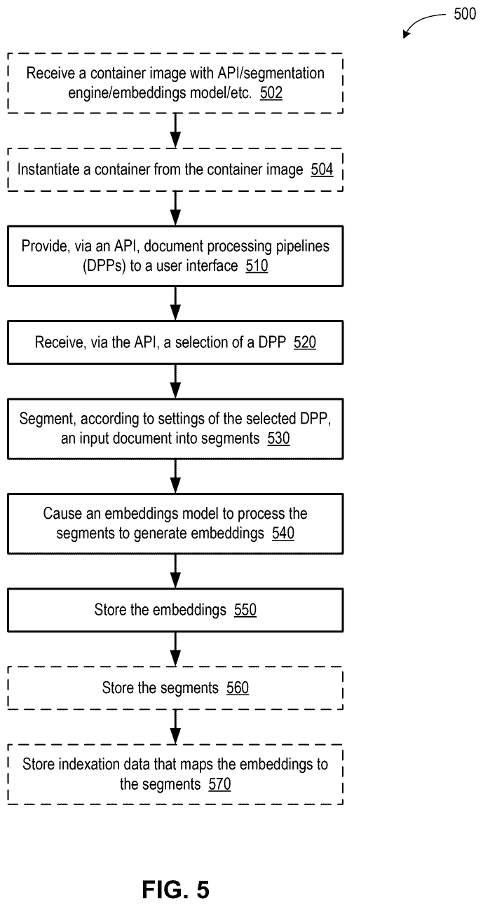

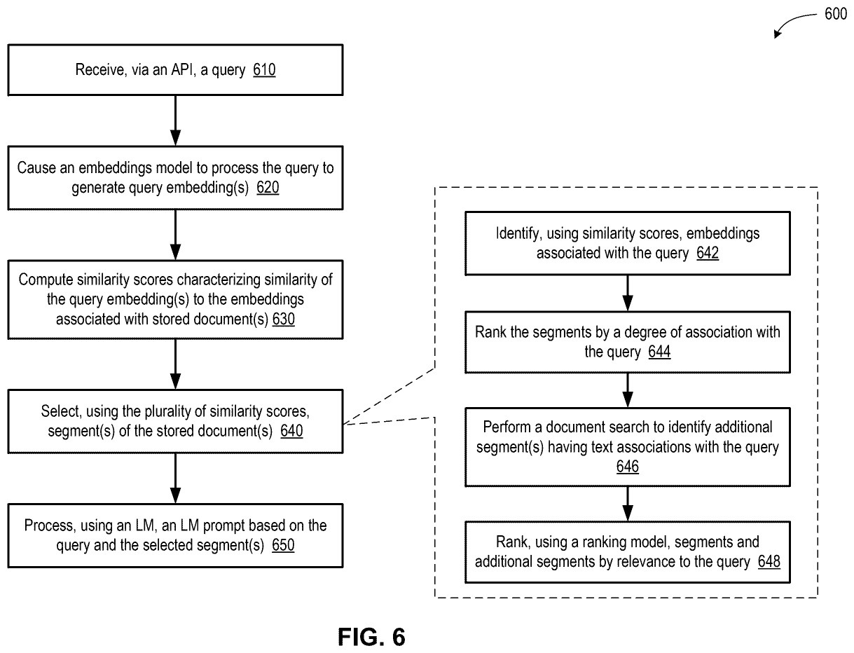

FIGS. 5 and 6 illustrate example methods 500 and 600 directed to efficient API-facilitated retrieval-augmented generation for AI model processing. Methods 500 and 600 may be used in the context of deployment and/or use of AI, including (but not limited) to the deployment and/or use of language models, visual language models, computer vision models, text-to-speech models, speech-to-text models, and/or other AI models where processing of an input into an AI model (e.g., text, image, speech, audio, video, digital assets, CAD, and/or any other data) may be improved by augmenting the input with an appropriate contextual information (e.g., instances of historical data, background data, sample data, and/or the like). In at least one embodiment, methods 500 and/or 600 may be performed using one or more processing units of client device 104, cloud server 112, RAG server 120 of FIG. 1, computing device 200 of FIG. 2, and/or some other computing device or a combination of computing devices. The one or more processing units (e.g., CPUs, GPUs, accelerators, PPUs, DPUs, etc.) performing methods 500 and/or 600 may include (or communicate with) one or more memory devices.

In at least one embodiment, methods 500 and/or 600 may be performed by the same computing device. In at least one embodiment, methods 500 and/or 600 may be performed by different computing devices. In at least one embodiment, processing units performing methods 500 and/or 600 may be executing instructions stored on a non-transient computer-readable storage media. In at least one embodiment, methods 500 and/or 600 may be performed using multiple processing threads (e.g., CPU threads and/or GPU threads), with individual threads executing one or more individual functions, routines, subroutines, or operations of the methods. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIGS. 5 and 6. Some operations of any of methods 500 and/or 600 may be performed concurrently with other operations. In at least one embodiment, one or more operations shown in FIGS. 5 and 6 may not always be performed.

FIG. 5 is a flow diagram of an example method 500 of an indexing stage of efficient API-facilitated RAG for AI model processing, according to at least one embodiment. At block 510, method 500 may include providing, using a processing device executing an application programming interface (API), a plurality of document processing pipelines (DPPs) to a user interface. In some implementations, the user interface may be located on a different device than the device that performs method 500. For example, with reference to FIG. 1, method 500 may be performed by cloud server 112 while the user interface may be on client device 104 remotely communicating with the cloud server 112 over a network (e.g., network 140). At block 520, method 500 may continue with receiving from the user interface, via the API, a selection (e.g., user selection) of a DPP from the plurality of DPPs.

At block 530, method 500 may include segmenting, according to predetermined settings of the selected DPP, an input document into a plurality of segments. In some embodiments, the input document may be received from a remote device (e.g., client device 104, a processing device associated with data store 150, and/or the like). The input document may include a text, one or more images, tables, data sets, audio files, and/or the like or any combination thereof. In some embodiments, the predetermined settings may include a size of an individual segment of the plurality of segments, an amount of overlap between adjacent segments of the plurality of segments, a selection of an embeddings model, and/or any combination thereof.

At block 540, method 500 may continue with causing an embeddings model (e.g., identified by the DPP selections or a default embeddings model) to process the plurality of segments to generate a plurality of embeddings. In some embodiments, the embeddings model may be deployed by the same computing device that performs method 500. In some embodiments, the embeddings model may be deployed by a different (e.g., remote) computing device (e.g., RAG server 120, and/or the like).

At block 550, method 500 may include causing the plurality of embeddings to be stored in a first data store. The first data store may be (or include) a memory device of the computing device that performs method 500. In some embodiments, the first data store may be a data store (e.g., data store 150) remote to the computing device that performs method 500. In some embodiments, operations of block 570 may include storing indexation data that maps the plurality of embeddings to the plurality of segments. In some embodiments, as indicated by the dashed block 560, method 500 may continue with causing the plurality of segments to be stored in at least the first data store or a second data store.

In some embodiments, operations of method 500 may be performed using a container infrastructure, as illustrated with dashed blocks 502 and 504. More specifically, at block 502, method 500 may include receiving, from a remote computing device, a container image. The container image may include the API that facilitates performance of method 500. In some implementations, the container image may further include the segmentation engine that segments the input document into the plurality of segments, the embeddings model, and/or other tools and modules. At block 504, method 500 may include executing the API in a container instantiated using the container image. The segmentation engine, the embeddings model, and/or other tools and modules received with the container image may also be executed in the instantiated container.

FIG. 6 is a flow diagram of an example method 600 of a query processing stage of efficient API-facilitated RAG for AI model processing, according to at least one embodiment. At block 610, method 500 may include receiving a query. The query may include a text, one or more image, tables, data sets, audio files, and/or the like or any combination thereof. The query may be received using a processing device executing an API. In some implementations, the API that facilitates the query processing stage of method 600 may be the same as the API that facilitates the indexing stage of method 500, e.g., a single API downloadable from RAG server 120 that supports both stages of RAG-facilitated AI operations. In some implementations the API that facilitates the query processing stage of method 600 may be different from the API that facilitates the indexing stage of method 500 (e.g., indexing API 310 in FIG. 4). In some implementations, in addition to receiving the query, operations of block 610 may also include selection of a DPP from a plurality of DPPs provided by the API. The selected DPP may include a maximum number of segments of documents to be identified in conjunction with the query. At block 620, method 600 may include causing an embeddings model to process the query to generate one or more query embeddings.

At block 630, method 600 may continue with computing a plurality of similarity scores characterizing similarity of the one or more query embeddings to a plurality of (stored) embeddings associated with one or more stored documents. At block 640, method 600 may continue with selecting, using the plurality of similarity scores, one or more segments of the one or more stored documents (e.g., first set of segments 442 in FIG. 4). The one or more selected segments may be from a single stored document or from multiple stored documents. The number of segments selected from a given document need not be limited. In some embodiments, selecting the one or more segments may include accessing stored indexation data (e.g., indexation 156 in FIG. 1) that maps the plurality of (stored) embeddings (e.g., embeddings 154) to the one or more stored documents (e.g., documents 152).

In some implementations, selecting the one or more segments may include one or more operations illustrated in the callout portion of FIG. 6. For example, at block 642, operations of method 600 may include identifying, using the plurality of similarity scores, one or more embeddings of the plurality of (stored) embeddings, the one or more identified embeddings corresponding to the one or more segments associated with the query. At block 644, operations of method 600 may include ranking, using the plurality of similarity scores, the one or more segments by a degree of association with the query.

In some implementations, at block 646, operations of method 600 may include performing a document search (e.g., a text search) to identify one or more additional segments (e.g., a second set of segments 432 in FIG. 4) of the one or more stored documents, the one or more additional segments having text associations with the query. At block 648, operations of method 600 may further include ranking, using a ranking model, a set of segments by relevance to the query. In some implementations, the set of segments being ranked may include the one or more segments identified using the embedding search (e.g., first set of segments 442 in FIG. 4) and the one or more additional segments identified using the document search (e.g., second set of segments 442 in FIG. 4).

At block 650, method 600 may include generating an LM prompt and processing the LM prompt using an LM to obtain a response to the query. The LM prompt may be based at least on the query and the one or more selected segments, e.g., segments identified using the embedding search and/or additional segments identified using the document search. In some implementations, the LM prompt may be generated using the ranked set of segments, e.g., by including both the segments and the corresponding rankings. The segments included in the LM prompt may include the segments identified using the embedding search and, in some embodiments, the additional segments identified using the document search.

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Inference and Training Logic

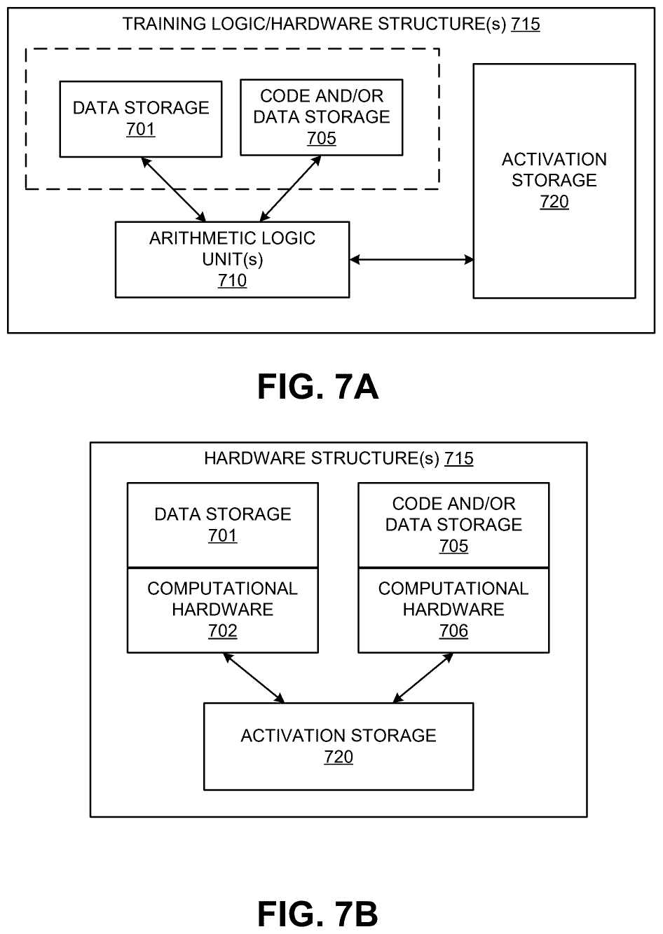

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

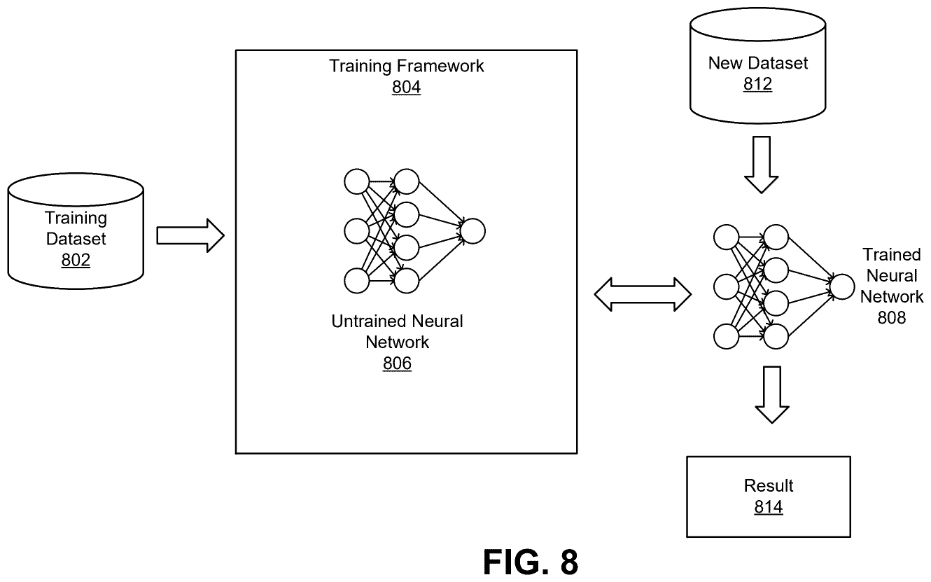

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

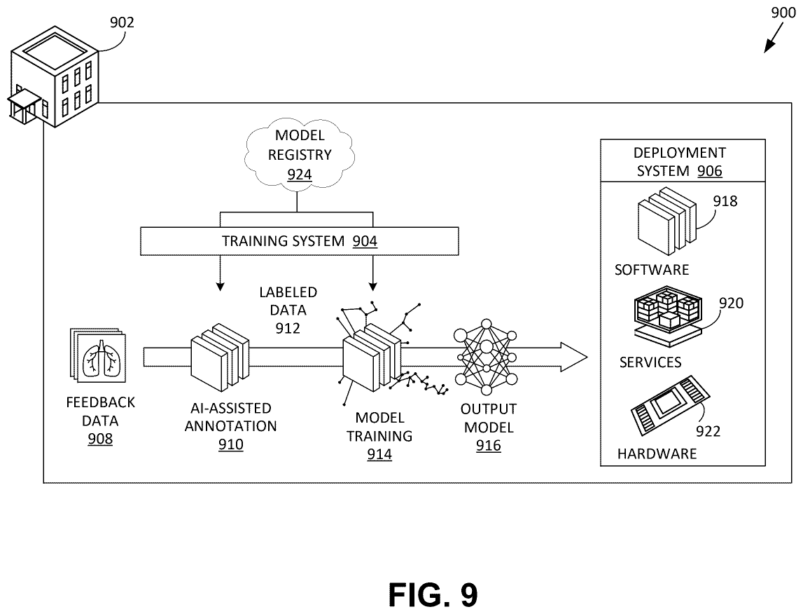

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

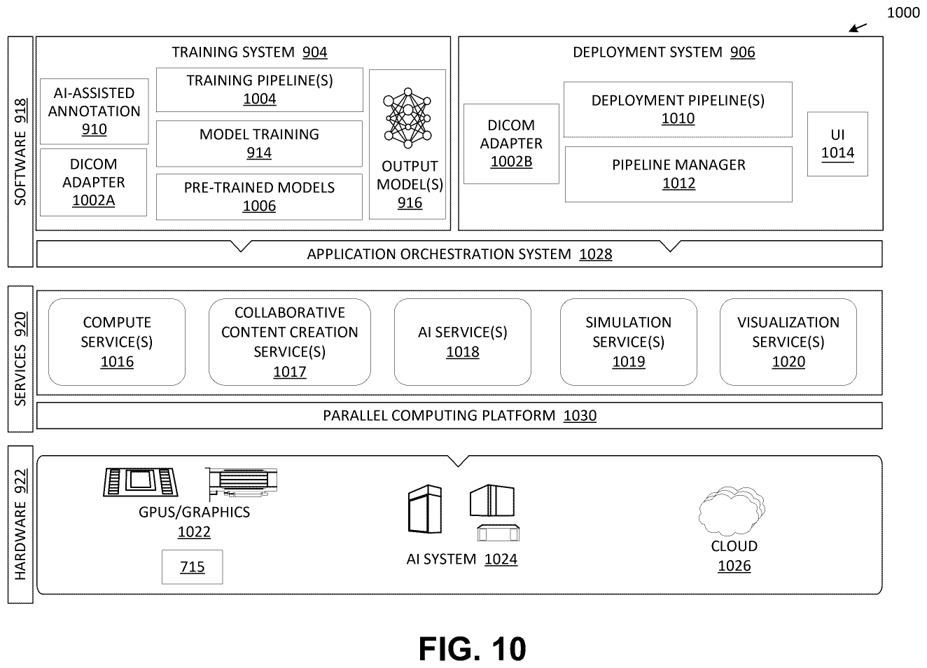

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA®) and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
providing, using a processing device executing an application programming interface (API), visual representations of a plurality of document processing pipelines (DPPs) for presentation within a user interface;
receiving, via the API, from the user interface, a selection of a DPP from the plurality of DPPs;
segmenting, according to predetermined settings of the selected DPP, an input document into a plurality of segments;
causing an embeddings model to process the plurality of segments to generate a plurality of embeddings; and
causing the plurality of embeddings to be stored in a data store.

2. The method of claim 1, wherein the predetermined settings comprise one or more of:
a size of an individual segment of the plurality of segments,
an amount of overlap between adjacent segments of the plurality of segments, or
a selection of the embeddings model.

3. The method of claim 1, further comprising:
causing the plurality of segments to be stored in at least the data store or a second data store.

4. The method of claim 3, further comprising:
storing indexation data that maps the plurality of embeddings to the plurality of segments.

5. The method of claim 1, wherein the input document is received from a client device remotely communicating with the processing device over a network.

6. The method of claim 1, further comprising:
receiving, from a remote computing device, a container image comprising the API; and
executing the API in a container instantiated using the container image.

7. The method of claim 6, wherein the container image further comprises at least one of:
a segmentation engine that segments the input document into the plurality of segments, or
the embeddings model.

8. The method of claim 1, further comprising:
receiving, using the API, a query;
causing the embeddings model to process the query to generate one or more query embeddings;
computing a plurality of similarity scores characterizing similarity of the one or more query embeddings to the plurality of embeddings;
selecting, using the plurality of similarity scores, one or more segments of the plurality of segments; and
generating a prompt into a language model (LM), wherein the prompt is based at least on the query and the one or more selected segments.

9. A method comprising:
receiving, using a processing device executing an application programming interface (API), a query;
causing an embeddings model to process the query to generate one or more query embeddings;
computing a plurality of similarity scores characterizing similarity of the one or more query embeddings to a plurality of embeddings associated with one or more stored documents;
selecting, using the plurality of similarity scores, one or more segments of the one or more stored documents; and
processing, using a language model (LM), an LM prompt to obtain a response to the query, wherein the LM prompt is based at least on the query and the one or more selected segments.

10. The method of claim 9, further comprising:
receiving a selection of a document processing pipeline (DPP) from a plurality of DPPs provided using the API, the selected DPP comprising a maximum number of segments to be identified.

11. The method of claim 9, wherein the selecting the one or more segments comprises:
identifying, using the plurality of similarity scores, one or more embeddings of the plurality of embeddings, the one or more identified embeddings corresponding to the one or more segments associated with the query; and
ranking, using the plurality of similarity scores, the one or more segments by a degree of association with the query.

12. The method of claim 9, wherein the selecting the one or more segments comprises:
performing a document search to identify one or more additional segments of the one or more stored documents, the one or more additional segments having text associations with the query; and
ranking, using a ranking model, a set of segments by relevance to the query, wherein the set of segments comprises:
the one or more segments, and
the one or more additional segments; and
wherein the LM prompt is generated using the ranked set of segments.

13. The method of claim 9, wherein the selecting the one or more segments comprises:
accessing stored indexation data that maps the plurality of embeddings to the one or more stored documents.

14. The method of claim 9, further comprising:
receiving, from a remote computing device, a container image comprising one or more of:
the API, or
the embeddings model; and
executing the one or more of the API or the embeddings model in a container instantiated using the container image.

15. The method of claim 9, wherein an individual document of the one or more stored documents is stored using operations comprising:
receiving, for the individual document, a selection of a document processing pipeline (DPP) from a plurality of DPPs provided using the API;
segmenting, according to predetermined settings of the selected DPP, the individual document into a plurality of segments;
causing an embeddings model to process the plurality of segments to generate a set of embeddings for the individual document; and
causing the set of embeddings to be stored in a data store.

16. The method of claim 15, wherein the predetermined settings comprise one or more of:
a size of an individual segment of the plurality of segments,
an amount of overlap between adjacent segments of the plurality of segments, or
a selection of the embeddings model.

17. A system comprising:
a processing device to:
receive, using an application programming interface (API), a query;
cause an embeddings model to process the query to generate one or more query embeddings;
compute a plurality of similarity scores characterizing similarity of the one or more query embeddings to a plurality of embeddings associated with one or more stored documents;
select, using the plurality of similarity scores, one or more segments of the one or more stored documents; and
process, using a language model (LM), an LM prompt to obtain a response to the query, wherein the LM prompt is based at least on the query and the one or more selected segments.

18. The system of claim 17, wherein to select the one or more segments, the processing device is to:
identify, using the plurality of similarity scores, one or more embeddings of the plurality of embeddings, the one or more identified embeddings corresponding to the one or more segments associated with the query; and
rank, using the plurality of similarity scores, the one or more segments by a degree of association with the query.

19. The system of claim 17, wherein to select the one or more segments, the processing device is to:
perform a document search to identify one or more additional segments of the one or more stored documents, the one or more additional segments having text associations with the query; and
rank, using a ranking model, a set of segments by relevance to the query, wherein the set of segments comprises:
the one or more segments, and
the one or more additional segments; and
wherein the LM prompt is generated using the ranked set of segments.

20. The system of claim 17, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
